(19) United States
(12) Patent Application Publication
(10) Pub. No.: US 2019/0065124 A1
(43) Pub. Date: Feb. 28, 2019

(54) INFORMATION PROCESSING APPARATUS, MEMORY CONTROLLER, AND CONTROL METHOD FOR INFORMATION PROCESSING APPARATUS

(71) Applicant: FUJITSU LIMITED, Kawasaki-shi (JP)

(72) Inventor: Daisuke Ito, Kawasaki (JP)

(73) Assignee: FUJITSU LIMITED, Kawasaki-shi (JP)

(21) Appl. No.: 16/109,864

(22) Filed: Aug. 23, 2018

(30) Foreign Application Priority Data
Aug. 30, 2017 (JP) 2017-165791

(51) Int. Cl. G06F 3/06

(52) U.S. Cl. CPC G06F 3/0661; G06F 3/0673; G06F 3/0659; G06F 3/0604

(57) ABSTRACT

An information processing apparatus includes, an arithmetic processing circuit that executes arithmetic processing, a memory that stores data, a storage processing circuit coupled to the arithmetic processing circuit and the memory that generates low precision data having a shorter data length than first data designated to be stored by a storage instruction received from the arithmetic processing circuit, and stores the generated low precision data in the memory, and a read processing circuit coupled to the arithmetic processing circuit and the memory that reads from the memory the low precision data corresponding to second data designated to be read by a read instruction received from the arithmetic processing circuit, returns the read low precision data to a format of the data length of the second data, and outputs the low precision data returned to the format to the arithmetic processing circuit.

### CROSS-REFERENCE TO RELATED APPLICATION

This application is based upon and claims the benefit of priority of the prior Japanese Patent Application No. 2017-165791, filed on Aug. 30, 2017, the entire contents of which are incorporated herein by reference.

### FIELD

The embodiments discussed herein are related to an information processing apparatus, a memory controller, and a control method for the information processing apparatus.

### BACKGROUND

In recent years, a technology called deep learning, which is a machine learning method of learning the characteristics of data to recognize and classify the data, has attracted attention. The deep learning has the characteristic of performing the same computations many times. For this reason, in deep learning, a GPU (Graphics Processing Unit) incorporating more arithmetic units than a CPU (Central Processing Unit) is used as an arithmetic processing unit in many cases.

However, as in the CPU, the GPU may have a low I/O (input/output) processing speed relative to the core speed, and there are cases where the overall processing of an information processing apparatus is delayed. Therefore, as a measure against the deterioration of the processing capability of the information processing apparatus due to the delay of the I/O processing, there has been proposed a method of using a cache memory. Some GPUs improve the delay due to the I/O processing by incorporating a cache memory.

As a technique for increasing the speed of the I/O processing, there has been a related art which improves the throughput between a memory controller and a memory when the bus bandwidth between the memory controller and the memory is smaller than the bus bandwidth between a CPU and the memory controller. In this related art, after an area corresponding to the data capacity before compression is secured as a storage area, the compressed data is actually stored in the secured storage area and the remaining areas are kept unused, thereby improving the throughput between the memory controller and the memory. Further, there has been a related art in which floating-point data is converted to fixed-point data when data of a format to be used in a processing device is written in a memory, and the fixed-point data is converted to the floating-point data when the data is read.

However, even in the case of using the technique such as using a cache memory, the memory access may be bottlenecked, and the overall processing of the information processing apparatus may be delayed. In particular, in the deep learning where the frequency of memory access is high, there is a concern that the throughput of the entire arithmetic processing such as the deep learning is greatly decreased due to the delay caused by the memory access processing.

In addition, in the case of using the related art in which the compressed data is stored in the secured storage area and the remaining storage areas are kept unused, data compression and decompression processing are performed between the CPU and the memory controller. However, it is difficult to compress and decompress data with a high throughput, and when learning a huge number of samples by the deep learning, a delay due to the data compression and decompression occurs, which makes it difficult to improve the overall throughput of the arithmetic processing and the computational efficiency.

Further, in the case of using the related art of converting between floating-point data and fixed-point data, an access occurs to a specific address on the memory for data conversion. For this reason, when converting a huge amount of data used in the deep learning, a number of processings of moving data to an arbitrary place after accessing a specific address and converting the data, which makes it difficult to improve the overall throughput of the arithmetic processing and the computational efficiency.

Related technologies are disclosed in, for example, Japanese Laid-Open Patent Publication Nos. 2007-004795 and 2004-023526.

### SUMMARY

According to an aspect of the embodiments, an information processing apparatus includes, an arithmetic processing circuit that executes arithmetic processing, a memory that stores data, a storage processing circuit coupled to the arithmetic processing circuit and the memory that generates low precision data having a shorter data length than first data designated to be stored by a storage instruction received from the arithmetic processing circuit, and stores the generated low precision data in the memory, and a read processing circuit coupled to the arithmetic processing circuit and the memory that reads from the memory the low precision data corresponding to second data designated to be read by a read instruction received from the arithmetic processing circuit, returns the read low precision data to a format of the data length of the second data, and outputs the low precision data returned to the format to the arithmetic processing circuit.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a view illustrating an example of a hardware configuration of a server;

FIG. 2 is a block diagram of a GPU;

FIG. 3 is a block diagram of a storage processing circuit;

FIG. 4 is a view illustrating an example of the configuration of a data header generation circuit;

FIG. 5 is a view for explaining a state of storing cancellation-of-significant digits data in a DIMM;

FIG. 6 is a block diagram of a read processing circuit;

FIG. 7 is a view illustrating an example of a configuration of an instruction division circuit;

FIG. 8 is a view illustrating an example of a configuration of a header determination circuit;

FIG. 9 is a view illustrating the state of signals in cancellation-of-significant digits processing and restoration-of-significant digits processing;

FIG. 10 is a flowchart of data storage processing and read processing by a memory controller according to a first embodiment;

FIG. 11 is a flowchart of data storage processing by a storage processing circuit according to the first embodiment; and

FIG. 12 is a flowchart of data read processing by a read processing circuit according to the first embodiment.

### DESCRIPTION OF EMBODIMENTS

Embodiments of an information processing apparatus, a memory controller, and a control method of the information processing apparatus disclosed in the present application will be described in detail below with reference to the drawings. In addition, the information processing apparatus, the memory controller, and the control method of the information processing apparatus disclosed in the present application are not limited by the following embodiments.

### First Embodiment

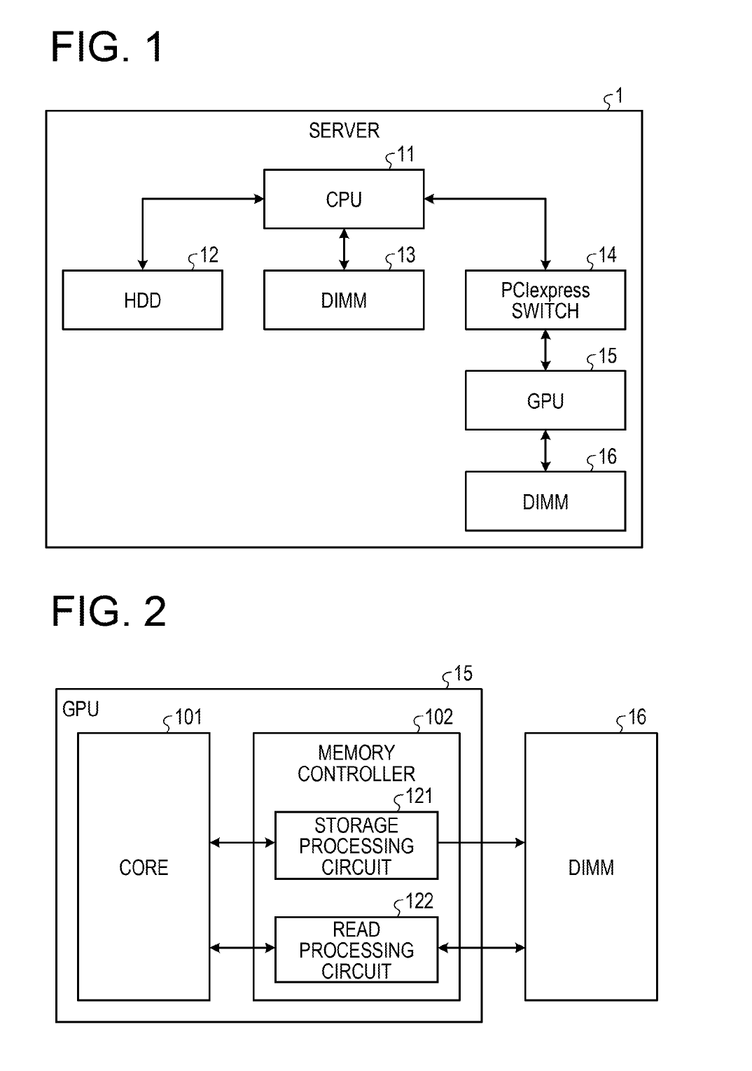

FIG. 1 is a view illustrating an example of a hardware configuration of a server. A server 1 as an information processing apparatus includes a CPU 11, an HDD (Hard Disk Drive) 12, and a DIMM (Dual-Inline Memory Module) 13 which is a storage device. The server 1 further includes a PCI (Peripheral Component Interconnect) express switch 14, a GPU 15, and a DIMM 16.

The CPU 11 is connected to the HDD 12, the DIMM 13, and the PCIexpress switch 14 via a bus. The HDD 12 is an auxiliary storage device and stores various programs. The DIMM 13 is a main storage device. The CPU 11 performs arithmetic processing by reading out a program stored in the HDD 12 and deploying and executing the program as a process on the DIMM 13. Further, the CPU 11 communicates with the GPU 15 via the PCIexpress switch 14.

The PCIexpress switch 14 connects the CPU 11 and the GPU 15 via a bus compliant with PCIexpress. Then, the PCIexpress switch 14 relays a communication between the CPU 11 and the GPU 15.

The GPU 15 communicates with the CPU 11 via the PCIexpress switch 14. Further, the GPU 15 is connected to the DIMM 16. In the present embodiment, the GPU 15 performs deep learning using the DIMM 16.

FIG. 2 is a block diagram of the GPU. As illustrated in FIG. 2, the GPU 15 has a core 101 and a memory controller 102.

The core 101 is an arithmetic processing unit that performs actual arithmetic processing. While FIG. 2 represents that the GPU 15 has a single core 101, the present disclosure is not limited thereto but the GPU 15 may have plural cores 101.

The core 101 stores/reads data in/from the DIMM 16 during the deep learning arithmetic processing. The storage of data is also called data store. The read of data is also called data load.

When storing data in the DIMM 16, the core 101 outputs to a storage processing circuit 121 of the memory controller 102 an instruction to store data including the head address and data length of a data storage destination. When outputting the data storage instruction, the core 101 outputs to the storage processing circuit 121 a cancellation-of-significant digits flag signal which indicates whether or not cancellation-of-significant digits processing is to be performed on the data to be stored. Thereafter, the core 101 receives from the storage processing circuit 121 a storage response which is a response to the data storage instruction.

When reading data from the DIMM 16, the core 101 outputs to a read processing circuit 122 of the memory controller 102 a data read instruction including the head address and data length of data to be read. Thereafter, the core 101 receives from the read processing circuit 122 a read response which is a response to the data storage instruction and the read data. This core 101 is an example of an “arithmetic processing circuit” and an “arithmetic processing device.”

The memory controller 102 includes the storage processing circuit 121 and the read processing circuit 122. This memory controller 102 is an example of a memory control device.

The storage processing circuit 121 receives the data storage instruction from the core 101. When receiving from the core 101 the cancellation-of-significant digits flag signal instructing the execution of the cancellation-of-significant digits processing on the data, the storage processing circuit 121 performs the cancellation-of-significant digits processing on the data designated by the data storage instruction to generate the cancellation-of-significant digits data. Here, the cancellation-of-significant digits processing is a process of lowering the accuracy of the data. Thereafter, the storage processing circuit 121 stores the cancellation-of-significant digits data in an area designated by the head address and data length included in the data storage instruction of the DIMM 16 and makes the remaining areas unused. The data designated by this data storage instruction corresponds to an example of “first data.” The cancellation-of-significant digits processing corresponds to an example of “precision lowering processing,” and the cancellation-of-significant digits data corresponds to an example of “low precision data.” The area indicated by the head address and data length included in the data storage instruction corresponds to an example of a “storage area,” and the area storing the cancellation-of-significant digits data corresponds to an example of a “partial area.”

In addition, when receiving from the core 101 a cancellation-of-significant digits flag signal instructing non-execution of the cancellation-of-significant digits processing on the data, the storage processing circuit 121 stores the data in the area designated by the head address and data length included in the data storage instruction of the DIMM 16.

After storing the data in the DIMM 16, the storage processing circuit 121 outputs the storage response to the core 101.

The read processing circuit 122 receives the data read instruction from the core 101. The data designated to be read by the data read instruction by the core 101 is an example of “second data.”

Then, the read processing circuit 122 reads data in an area of the cancellation-of-significant digits data length from the head address in the area designated by the head address and data length included in the data read instruction. Thereafter, the read processing circuit 122 determines whether or not the read data is the cancellation-of-significant digits data. When the read data is the cancellation-of-significant digits data, the read processing circuit 122 avoids reading the remaining areas except the area designated by the head address and data length included in the data read instruction. Then, the read processing circuit 122 executes restoration-of-significant digits processing of restoring the read cancellation-of-significant digits data to a format having precision before the cancellation-of-significant digits processing.

When the read data is not the cancellation-of-significant digits data, the read processing circuit 122 reads data from the remaining areas except the area designated by the head address and data length included in the data read instruction.

Thereafter, the read processing circuit 122 outputs a read response together with the read data from the DIMM 16 to the core 101.

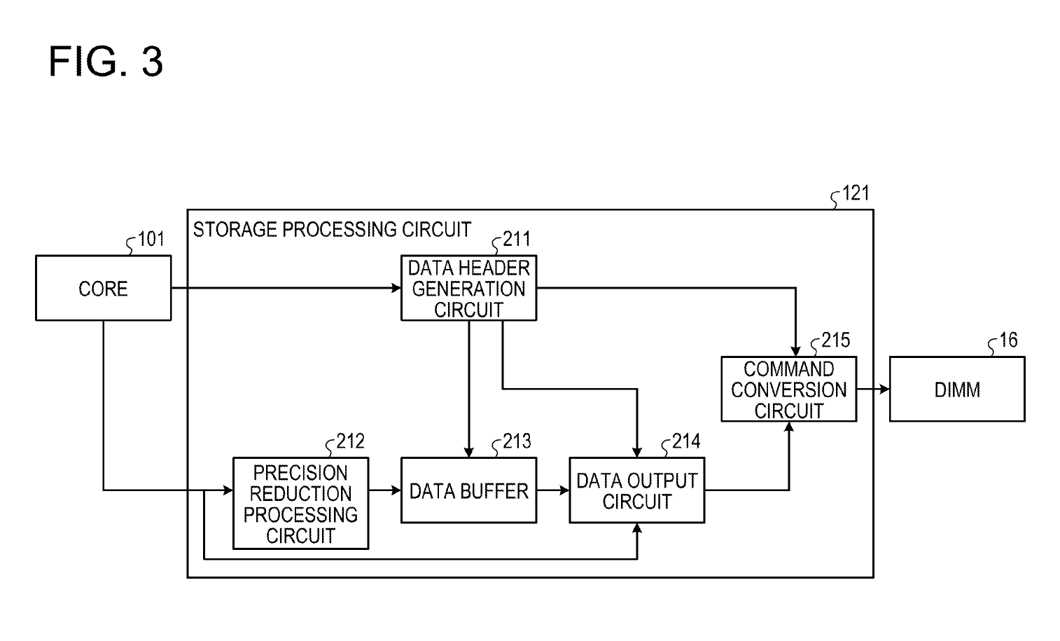

Next, the details of the storage processing circuit 121 will be further described with reference to FIG. 3. FIG. 3 is a block diagram of the storage processing circuit. As illustrated in FIG. 3, the storage processing circuit 121 includes a data header generation circuit 211, a precision reduction processing circuit 212, a data buffer 213, a data output circuit 214, and a command conversion circuit 215.

The data header generation circuit 211 receives the head address, the data length, and the data included in the data storage instruction input from the core 101. Further, the data header generation circuit 211 receives the cancellation-of-significant digits flag signal. Then, the data header generation circuit 211 determines whether or not to execute the cancellation-of-significant digits processing.

When the cancellation-of-significant digits processing is executed, the data header generation circuit 211 outputs the data length of the cancellation-of-significant digits data, together with the head address, to the command conversion circuit 215. Further, the data header generation circuit 211 outputs a cancellation-of-significant digits instruction signal instructing the cancellation-of-significant digits instruction and a data header for identifying the cancellation-of-significant digits data to the data buffer 213. Further, the data header generation circuit 211 outputs the cancellation-of-significant digits instruction signal to the data output circuit 214. Thereafter, the data header generation circuit 211 outputs an output instruction signal instructing the output of data to the data buffer 213.

When the cancellation-of-significant digits processing is not executed, the data header generation circuit 211 outputs the data length included in the data storage instruction, together with the head address, to the command conversion circuit 215.

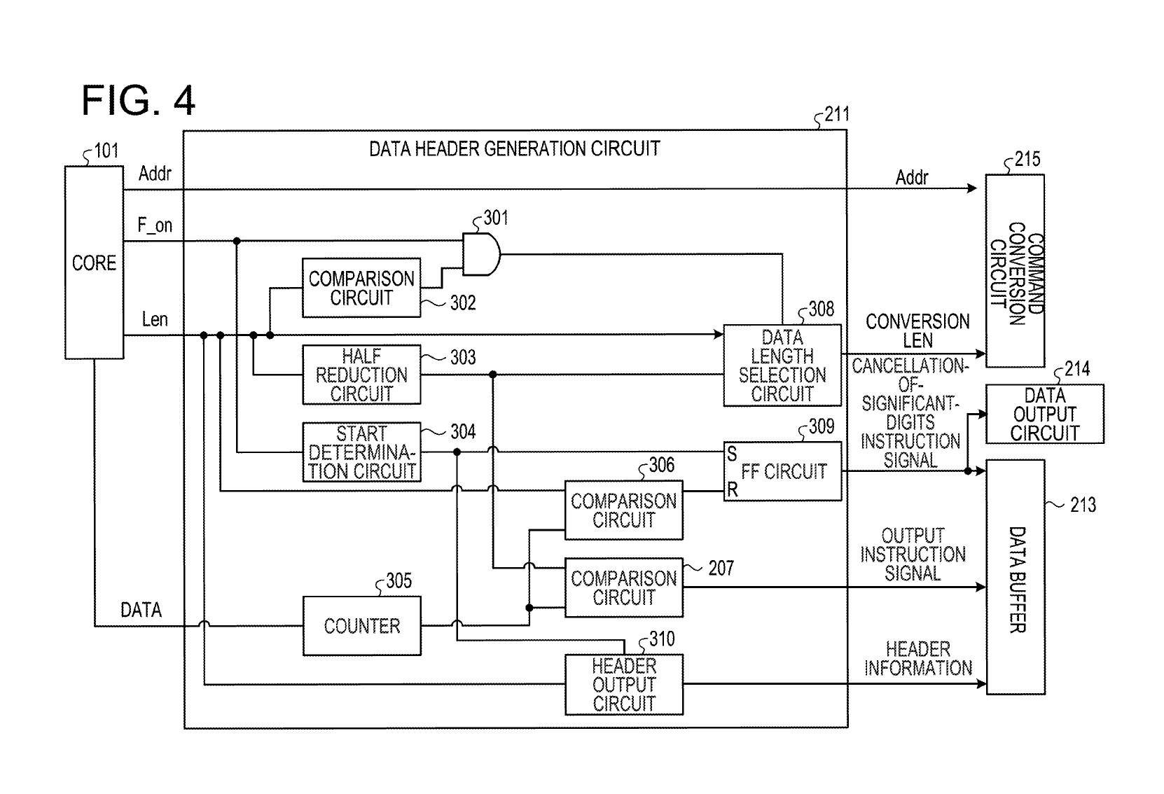

Here, a specific example of the configuration of the data header generation circuit 211 will be described with reference to FIG. 4. FIG. 4 is a view illustrating an example of the configuration of the data header generation circuit.

The data header generation circuit 211 includes a determination circuit 301, a comparison circuit 302, a half reduction circuit 303, a start determination circuit 304, a counter 305, a comparison circuit 306, a comparison circuit 307, a data length selection circuit 308, a flip-flop (FF) circuit 309, and a header output circuit 310.

In FIG. 4, the symbol Addr (Address) represents a head address. The symbol F (Flag)_on represents a cancellation-of-significant digits flag signal. The symbol Len (Length) represents the data length included in the data storage instruction. The symbol Data represents data instructed to be stored in the DIMM 13 by a store instruction.

The comparison circuit 302 has in advance a data length threshold value for determining whether or not to execute the cancellation-of-significant digits processing. This data length threshold value is an example of a “predetermined value.” When the data length of the data instructed to be stored in the DIMM 13 by the storage instruction is relatively short, since the effect of improving the performance of data transfer is small even when the cancellation-of-significant digits processing is executed, the comparison circuit 302 determines to execute the cancellation-of-significant digits processing on data whose data length is equal to or greater than the data length threshold value.

The comparison circuit 302 receives the data length included in the storage instruction input from the core 101. Next, the comparison circuit 302 compares the data length included in the storage instruction with the data length threshold value. Then, the comparison circuit 302 outputs the result of the comparison of the data length included in the storage instruction with the data length threshold value to the determination circuit 301.

The determination circuit 301 receives the cancellation-of-significant digits flag signal input from the core 101. In addition, the determination circuit 301 receives from the comparison circuit 302 the result of the comparison of the data length included in the storage instruction with the data length threshold value. Then, when the cancellation-of-significant digits flag signal instructs the execution of the cancellation-of-significant digits processing and the data length included in the storage instruction is equal to or larger than the data length threshold value, the determination circuit 301 outputs a signal to the data length selection circuit 308 instructing the output of the cancellation-of-significant digits data length which is the data length of the cancellation-of-significant digits data.

The half reduction circuit 303 receives the data length included in the storage instruction input from the core 101. Next, the half reduction circuit 303 calculates the length of half of the data length and sets the calculated value as the cancellation-of-significant digits data length. Then, the half reduction circuit 303 outputs the cancellation-of-significant digits data length to the comparison circuit 307 and the data length selection circuit 308.

The data length selection circuit 308 receives the data length included in the storage instruction input from the core 101. In addition, the data length selection circuit 308 receives the cancellation-of-significant digits data length from the half reduction circuit 303. Then, the data length selection circuit 308 determines whether or not a signal instructing the output of the cancellation-of-significant digits data length has been received from the determination circuit 301.

When a signal instructing the output of the cancellation-of-significant digits data length is not being received, the data length selection circuit 308 outputs the data length included in the storage instruction to the command conversion circuit 215. When a signal instructing the output of the cancellation-of-significant digits data length is being received, the data length selection circuit 308 outputs the cancellation-of-significant digits data length to the command conversion circuit 215. The conversion Len output from the data length selection circuit 308 illustrated in FIG. 4 represents the data length included in the storage instruction or the cancellation-of-significant digits data length.

The start determination circuit 304 receives the cancellation-of-significant digits flag signal. Then, when the cancellation-of-significant digits flag signal is input instructing the execution of the cancellation-of-significant digits processing, the start determination circuit 304 outputs a start signal of the cancellation-of-significant digits processing to the FF circuit 309.

For example, when a value of the cancellation-of-significant digits flag signal is Low, it represents a non-execution of the cancellation-of-significant digits processing. When the value is High, which instructs the execution of the cancellation-of-significant digits processing, the start determination circuit 304 detects the rising edge of the cancellation-of-significant digits flag signal. When detecting the rising edge of the cancellation-of-significant digits flag signal, the start determination circuit 304 outputs a start signal of the cancellation-of-significant digits processing to the FF circuit 309.

The counter 305 receives the data instructed to be stored in the DIMM 13 by the store instruction input from the core 101. Then, the counter 305 starts counting the length of the received data out of the data instructed to be stored in the DIMM 13. For example, the counter 305 counts the length of data by counting the number of clocks. Then, the counter 305 outputs the count value to the comparison circuits 306 and 307.

The comparison circuit 306 receives the data length included in the storage instruction input from the core 101. Further, the comparison circuit 306 receives from the counter 305 the count value indicating the length of the received data. When the count value reaches the data length included in the storage instruction, that is, when all the reception of the data included in the storage instruction is completed, the comparison circuit 306 outputs an end signal of the cancellation-of-significant digits processing to the FF circuit 309.

The FF circuit 309 is a set reset type flip-flop. In FIG. 4, a terminal S in the FF circuit 309 represents a set terminal. A terminal R in the FF circuit 309 represents a reset terminal. When the start signal of the cancellation-of-significant digits processing output from the start determination circuit 304 is received at the set terminal, the FF circuit 300 outputs the cancellation-of-significant digits instruction signal indicating the execution of the cancellation-of-significant digits processing to the data buffer 213 and the data output circuit 214. When the end signal of the cancellation-of-significant digits processing output from the comparison circuit 306 is received at the reset terminal, the FF circuit 300 stops the output of the cancellation-of-significant digits instruction signal to the data buffer 213 and the data output circuit 214.

The comparison circuit 307 receives the cancellation-of-significant digits data length from the half reduction circuit 303. Further, the comparison circuit 306 receives from the counter 305 the count value indicating the length of the received data. Then, when the count value reaches the cancellation-of-significant digits data length, that is, when the reception of the data of the cancellation-of-significant digits data length is completed, the comparison circuit 307 outputs an output instruction signal to the data buffer 213.

The header output circuit 310 generates header information indicating that the data is cancellation-of-significant digits data. This header information has a pattern which is not normally possible when including up to ECC (Error Check and Correct) information, that is, a pattern which is not detected as an error. Hereinafter, the pattern of the header information generated by the header output circuit 310 is referred to as a unique pattern. The header information indicating that this data is cancellation-of-significant digits data is an example of “identification information.”

In addition, the header output circuit 310 receives the data length included in the storage instruction input from the core 101. Then, the header output circuit 310 stores the header information having the unique pattern in a single memory entry corresponding to an area of a single column starting from the head address in a memory space, and generates a data header in which the data length is stored in the next memory entry. Thereafter, when the start signal of the cancellation-of-significant digits processing is received from the start determination circuit 304, the header output circuit 310 outputs the generated data header to the data buffer 213.

Referring back to FIG. 3, the precision reduction processing circuit 212 receives the data instructed to be stored in the DIMM 13 by the storage instruction input from the core 101. Then, the precision reduction processing circuit 212 generates the cancellation-of-significant digits data by carrying out the cancellation-of-significant digits processing to reduce the data precision to half of the precision of the acquired data. In case of 32-bit data, the data before reducing the data precision to half is sometimes called “single precision data,” and the 16-bit data with the precision of the single precision data reduced by half is sometimes called “half precision data.” For example, when the acquired data is 10-digit information, the precision reduction processing circuit 212 creates the cancellation-of-significant digits data including information of the first ten digits. Then, the precision reduction processing circuit 212 outputs the created cancellation-of-significant digits data to the data buffer 213.

The data buffer 213 is a buffer for temporarily storing data. Further, when the data to be subjected to the cancellation-of-significant digits processing begins to be input from the core 101, the data buffer 213 receives a cancellation-of-significant digits signal from the data header generation circuit 211. In addition, the data buffer 213 acquires from the data buffer 213 a data header including the information having the unique pattern and the data length designated by the storage instruction. Then, the data buffer 213 stores the acquired data header. Next, when the cancellation-of-significant digits instruction signal is received, the data buffer 213 starts storing the cancellation-of-significant digits data input from the precision reduction processing circuit 212.

Thereafter, at the point of time when the reception of the data of the cancellation-of-significant digits data length is completed, the data buffer 213 receives a data output instruction signal from the data header generation circuit 211. When the data output instruction signal is received, the data buffer 213 begins outputting the stored data header and data. Thereafter, the data buffer 213 continues to output the cancellation-of-significant digits data input from the precision reduction processing circuit 212 until the input of the cancellation-of-significant digits instruction signal from the data header generation circuit 211 is stopped, that is, until the reception of the data of the data length included in the storage instruction is completed.

In this way, when data having half of the data length indicated by the storage instruction is received, an empty interval does not occur at the time of transmission of consecutive cancellation-of-significant digits data, which results in shortened time for data transfer. Further, data may be stored in the DIMM 13 with no gap. In other words, by receiving more than half of the original data before the precision reduction, it is possible to prevent the empty interval from occurring between the consecutive cancellation-of-significant digits data.

In the present embodiment, the cancellation-of-significant digits processing that halves the data length is performed. However, even when the cancellation-of-significant digits processing with different data lengths is performed, the empty interval can be avoided during transmission by the following method. For example, in a case of performing the cancellation-of-significant digits processing to make the data length 1/n of the original data length, by starting the output of the data after receiving the data of (1−1/n) of the data length indicated by the storage instruction, it is possible to prevent an empty interval from occurring in transmission of consecutive cancellation-of-significant digits processing data. This is because a speed at which data is consumed on the transmitting side is the same, regardless of whether or not the cancellation-of-significant digits processing is performed. Therefore, when the data length is set to 1/n, it may be thought that the data is consumed n times as fast as the original size data in transmission. For this reason, for example, in a case of performing the cancellation-of-significant digits processing to make the data length ¼ of the original data length, the data is consumed four times as fast as the original size data in transmission. In this case, by starting transmission after receiving the data of ¾ of the total length of the original data, no empty interval will occur in transmission. That is, in the case of performing the cancellation-of-significant digits processing to make the data length 1/n of the original data length, it can be said that it is better to start the output of data after receiving the data of (1−1/n) of the data length indicated by the storage instruction.

The data output circuit 214 receives the data instructed to be stored in the DIMM 13 by the storage instruction input from the core 101. In addition, when the cancellation-of-significant digits processing is performed, the data output circuit 214 receives from the data buffer 213 the data header including the header information having the unique pattern and the data length designated by the storage instruction, and the cancellation-of-significant digits data. In addition, when the cancellation-of-significant digits processing is performed, the data output circuit 214 receives the cancellation-of-significant digits instruction signal from the data header generation circuit 211.

When the cancellation-of-significant digits instruction signal has been received from the data header generation circuit 211, the data output circuit 214 outputs to the command conversion circuit 215 the data header and the cancellation-of-significant digits data input from the data buffer 213. When the cancellation-of-significant digits instruction signal has not been received from the data header generation circuit 211, the data output circuit 214 outputs to the command conversion circuit 215 the data included in the storage instruction input from the core 101.

In the case where the cancellation-of-significant digits processing is performed, the command conversion circuit 215 receives the head address and the cancellation-of-significant digits data length from the data header generation circuit 211. In addition, the command conversion circuit 215 receives from the data output circuit 214 the data header including the header information having the unique pattern and the data length designated by the storage instruction, and the cancellation-of-significant digits data.

Next, the command conversion circuit 215 determines storage of the data header in two memory entries starting from the head address in the memory space of the DIMM 13. Further, the command conversion circuit 215 determines to arrange the cancellation-of-significant digits data in the subsequent area of the DIMM 13. Then, the command conversion circuit 215 generates a storage instruction for the DIMM 13 that arranges the cancellation-of-significant digits data according to the determined arrangement information. Thereafter, the command conversion circuit 215 outputs the generated storage instruction to the DIMM 16, and stores the data header and the cancellation-of-significant digits data in the DIMM 13.

Meanwhile, in the case where the cancellation-of-significant digits processing is not performed, the command conversion circuit 215 receives the head address and the data length included in the storage instruction from the data header generation circuit 211. In addition, the command conversion circuit 215 receives the data included in the storage instruction from the data output circuit 214. Then, the command conversion circuit 215 generates a storage instruction for the DIMM 13 instructing storage of data in an area of the data length starting from the head address of the memory space of the DIMM 13. Thereafter, the command conversion circuit 215 outputs the generated storage instruction to the DIMM 16 to store the data in the DIMM 13.

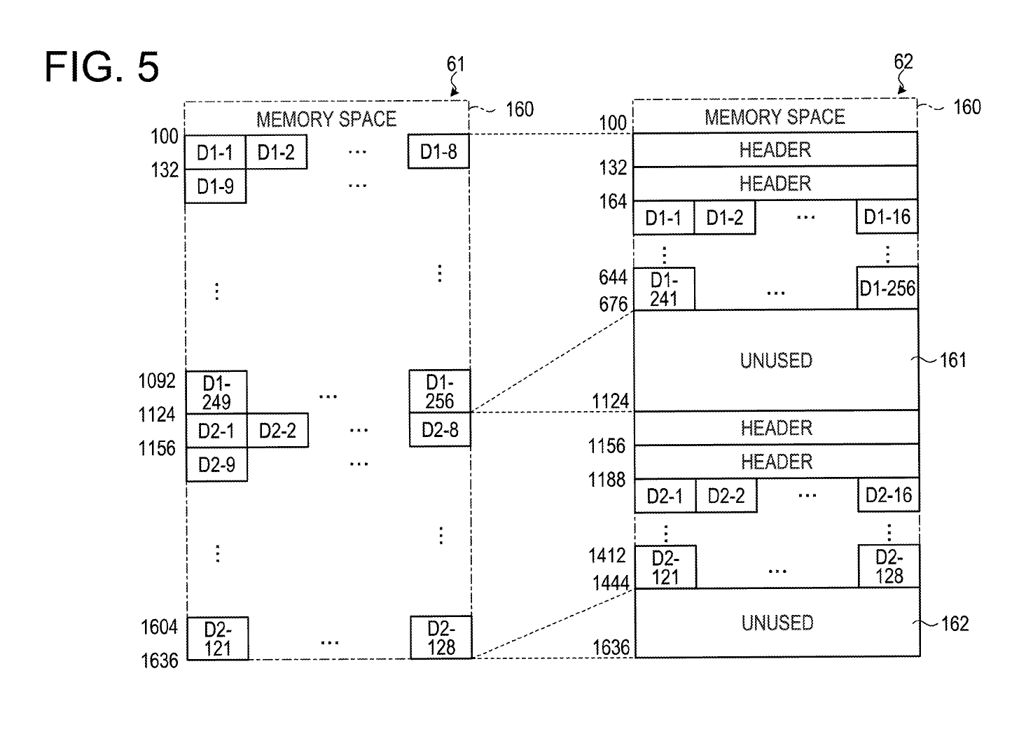

FIG. 5 is a view for explaining the storage state of the cancellation-of-significant digits data in the DIMM. The arrangement state 61 in FIG. 5 represents a case where data is arranged without performing the cancellation-of-significant digits processing. The arrangement state 62 represents a case where the same data as in the left side is arranged by performing the cancellation-of-significant digits processing. A memory space 160 is a space representing an address where the data of the DIMM 13 is stored, and the size of a single memory entry is 32 bytes. A number attached to the left side of the memory space 160 represents an address number. The symbol Data D1-1 to D1-256 represents a single data D1. The symbol Data D2-1 to D2-128 represents a single data D2. Further, each of the data D1-1 to D1-256 and the data D2-1 to D2-128 in the arrangement state 61 represents floating point data of 4 bytes when no cancellation-of-significant digits processing is performed. Further, each of the data D1-1 to D1-256 and the data D2-1 to D2-128 in the arrangement state 62 represents floating point data of 2 bytes after the cancellation-of-significant digits processing is performed.

As illustrated in the arrangement state 61, when no cancellation-of-significant digits processing is performed, the data D1-1 to D1-256 of 1024 bytes are stored in areas of the memory space 160 of the DIMM 13 whose address numbers are 100 to 1123. In addition, the data D2-1 to D2-128 of 512 bytes are stored in areas of the memory space 160 whose address numbers are 1124 to 1636.

Meanwhile, when the cancellation-of-significant digits processing is performed, the header information having the unique pattern is stored in a single memory entry from the head address, that is, in areas whose address numbers are 100 to 132. In addition, information on the data length designated by the core 101 is stored in the next memory entry, that is, in areas whose address numbers are 132 to 164. Thus, two memory entries from the head address are data headers.

Furthermore, since the size of the data D1-1 to D1-256 subjected to the cancellation-of-significant digits processing is halved, the data are stored in areas whose address numbers are 164 to 676. Then, the remaining areas with the address numbers up to 1124 in the memory space 160 are unused areas 161.

Likewise, for the data D2 as well, two memory entries from the head address whose address number is 1124 are data headers. Then, since the size of the data D2-1 to D2-128 subjected to the digit processing is halved, the address numbers are stored in the area from 1188 to 1444. Then, the remaining area where the address number of the memory space 160 is up to 1636 becomes the unused area 162.

For example, the used area of the memory space 160 storing the data D1 is 576 bytes when the cancellation-of-significant digits processing is performed, and is reduced to 44% of that in the case where no cancellation-of-significant digits processing is performed. Further, the used area of the memory space 160 storing the data D2 is 320 bytes when the cancellation-of-significant digits processing is performed, and is reduced to 38% of that in the case where no cancellation-of-significant digits processing is performed. Therefore, when the data is stored, the utilization rate of the bus connecting the GPU 15 and the DIMM 16 decreases by the amount corresponding to the reduced size of the storage data, so that the GPU 15 can transfer the data in a short time.

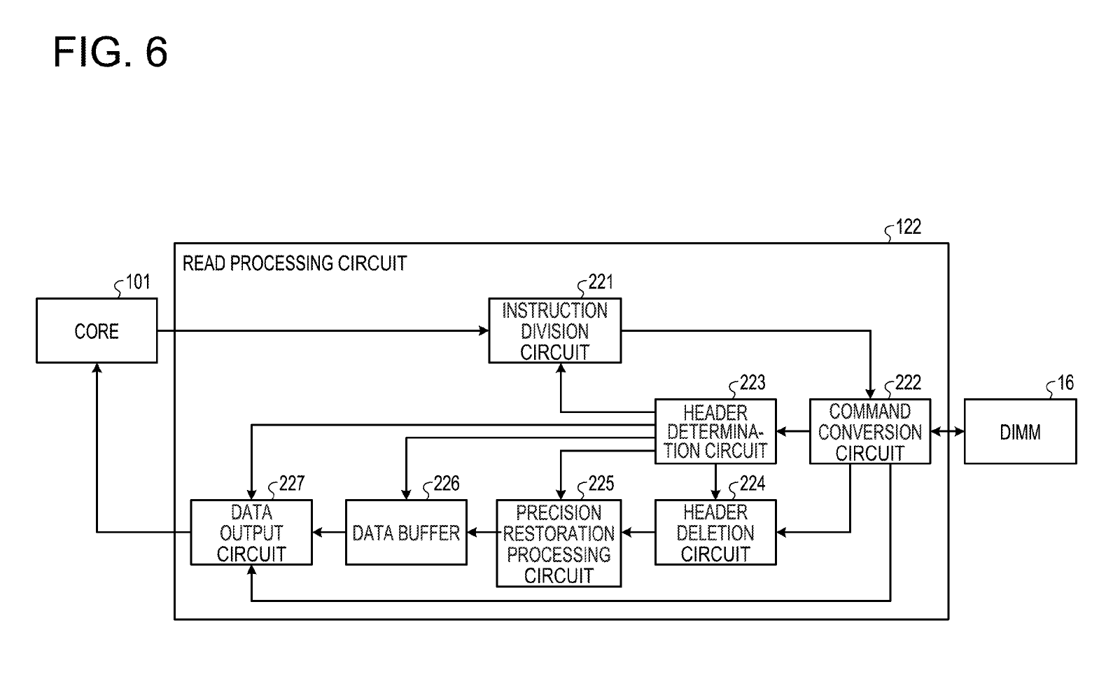

Next, the details of the read processing circuit 122 will be further described with reference to FIG. 6. FIG. 6 is a block diagram of the read processing circuit. As illustrated in FIG. 6, the read processing circuit 122 includes an instruction division circuit 221, a command conversion circuit 222, a header determination circuit 223, a header deletion circuit 224, a precision restoration processing circuit 225, a data buffer 226, and a data output circuit 227.

The instruction division circuit 221 receives from the core 101 a read instruction including the head address at which data to be read is stored and the data length of the data to be read. Next, the instruction division circuit 221 divides the acquired read instruction into two instructions, that is, a first half read instruction for reading the first half portion of the data designated to be read and a second half read instruction for reading the second half portion. Then, the instruction division circuit 221 outputs the first half read instruction to the command conversion circuit 222. Hereinafter, the data designated to be read by the first half read instruction will be referred to as first half data, and the data designated to be read by the second half read instruction will be referred to as second half data.

In the present embodiment, the data subjected to the cancellation-of-significant digits processing that halves the data length is read. However, even when the cancellation-of-significant digits processing with different data lengths is performed, the data can be read according to the following method. For example, in a case of performing the cancellation-of-significant digits processing to make the data length 1/n of the original data length, the instruction division circuit 221 generates a read instruction to read data of 1/n length from the head of the data designated to be read and a read instruction to read the following data of (1−1/n) length. By using these two instructions, it is possible to appropriately read the data even when the cancellation-of-significant digits processing with different data lengths is performed.

Thereafter, when a second half output instruction signal is received from the header determination circuit 223, the instruction division circuit 221 outputs the second half read instruction to the command conversion circuit 222. Meanwhile, when the second half output instruction signal is not received from the header determination circuit 223, the instruction division circuit 221 discards the second half read instruction.

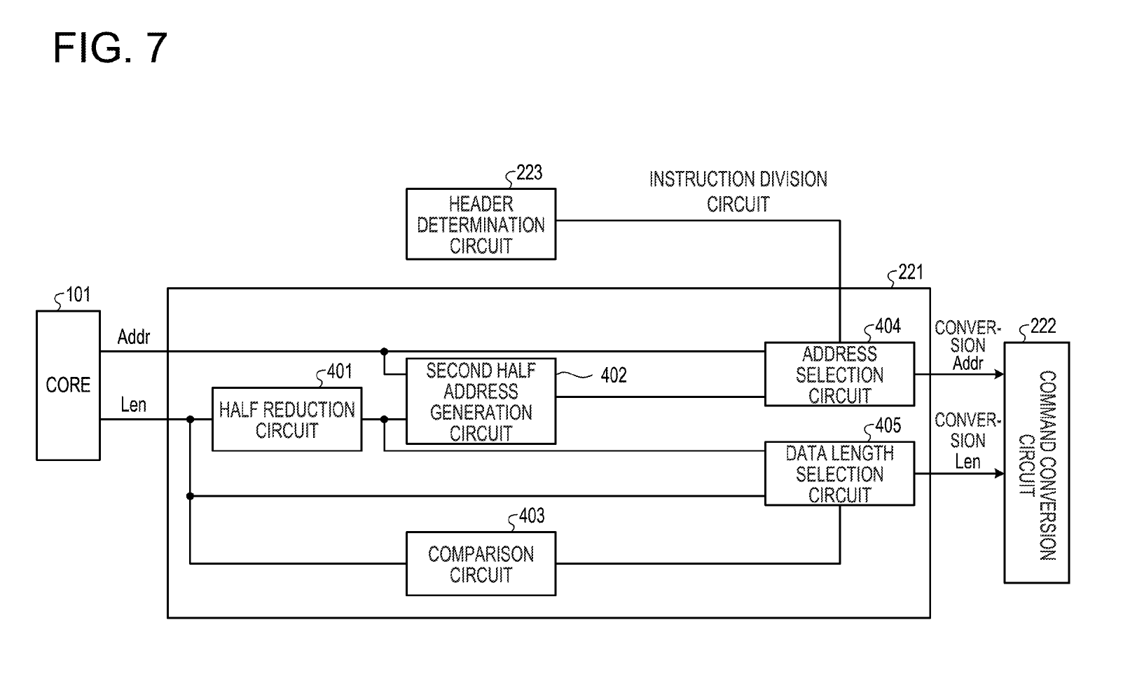

Here, a specific example of the configuration of the instruction division circuit 221 will be described with reference to FIG. 7. FIG. 7 is a view illustrating an example of the configuration of the instruction division circuit.

The instruction division circuit 221 includes a half reduction circuit 401, a second half address generation circuit 402, a comparison circuit 403, an address selection circuit 404, and a data length selection circuit 405. In FIG. 7, the symbol Addr represents the head address of the data to be read included in the read instruction. In FIG. 7, the symbol Len represents the data length of the data to be read included in the read instruction. Since the core 101 does not know that the cancellation-of-significant digits processing has been performed by the memory controller 102, the core 101 also designates the data length specified by the storage instruction by itself in the read instruction.

The half reduction circuit 401 receives the data length included in the read instruction input from the core 101. Next, the half reduction circuit 401 calculates half of the data length and sets the calculated value as the cancellation-of-significant digits data length. Then, the half reduction circuit 401 outputs the cancellation-of-significant digits data length to the second half address generation circuit 402 and the data length selection circuit 405.

The second half address generation circuit 402 receives the head address included in the read instruction input from the core 101. In addition, the second half address generation circuit 402 receives the cancellation-of-significant digits data length from the half reduction circuit 401. Then, the second half address generation circuit 402 obtains the head address of the second half data. For example, the second half address generation circuit 402 changes the cancellation-of-significant digits data length to an address size in the memory space 160. Next, the second half address generation circuit 402 adds the cancellation-of-significant digits data length to the head address to obtain the head address of the second half data. Thereafter, the second half address generation circuit 402 outputs the obtained head address of the second half data to the address selection circuit 404.

The address selection circuit 404 receives the head address included in the read instruction input from the core 101. Further, the address selection circuit 404 receives the head address of the second half data from the second half address generation circuit 402.

When the second half output instruction signal is not received from the header determination circuit 223, the address selection circuit 404 outputs the head address included in the read instruction to the command conversion circuit 222. Meanwhile, when the second half output instruction signal is received from the header determination circuit 223, the address selection circuit 404 outputs the head address of the second half data to the command conversion circuit 222. The conversion Addr output from the address selection circuit 404 in FIG. 7 represents the head address included in the read instruction or the head address of the second half data.

The comparison circuit 403 has a data length threshold value in advance. In addition, the comparison circuit 403 receives the data length included in the read instruction input from the core 101. Then, the comparison circuit 403 compares the data length included in the read instruction with the data length threshold value. Thereafter, the comparison circuit 403 outputs the result of the comparison of the data length included in the read instruction with the data length threshold value to the data length selection circuit 405.

The data length selection circuit 405 receives the data length included in the read instruction input from the core 101. In addition, the data length selection circuit 405 receives the cancellation-of-significant digits data length from the half reduction circuit 401.

Further, the data length selection circuit 405 receives from the comparison circuit 403 the result of the comparison between the data length included in the read instruction and the data length threshold value. When the data length included in the read instruction is equal to or larger than the data length threshold value, the cancellation-of-significant digits data length is output to the command conversion circuit 222. Meanwhile, when the data length included in the read instruction is smaller than the data length threshold value, the data length included in the read instruction is output to the command conversion circuit 222. The conversion Len output from the data length selection circuit 405 in FIG. 7 represents the data length included in the read instruction or the cancellation-of-significant digits data length.

Referring back to FIG. 6, when the data length included in the read instruction is equal to or larger than the data length threshold value, the command conversion circuit 222 receives from the command division circuit 221 the first half read instruction including the head address and the cancellation-of-significant digits data length included in the read instruction output from the core 101. Then, the command conversion circuit 222 converts the first half read instruction into a read instruction for the DIMM 13 and outputs the read instruction to the DIMM 13. Thereafter, the command conversion circuit 222 acquires the first half data from the DIMM 13 and outputs it to the header determination circuit 223, the header deletion circuit 224 and the data output circuit 227. This first half data includes a data header.

Thereafter, when the read data is the cancellation-of-significant digits data, the command conversion circuit 222 receives from the instruction division circuit 221 the second half read instruction including the head address of the second half data and the cancellation-of-significant digits data length. Then, the command conversion circuit 222 converts the second half read instruction into a read instruction for the DIMM 13 and outputs the read instruction to the DIMM 13. Thereafter, the command conversion circuit 222 acquires the second half data from the DIMM 13 and outputs the second half data to the header deletion circuit 224 and the data output circuit 227.

Meanwhile, when the data length included in the read instruction is smaller than the data length threshold value, the command conversion circuit 222 receives from the instruction division circuit 221 the first half read instruction including the head address and the data length included in the read instruction output from the core 101. Then, the command conversion circuit 222 converts the first half read instruction into a read instruction for the DIMM 13 and outputs the read instruction to the DIMM 13. Thereafter, the command conversion circuit 222 acquires the first half data from the DIMM 13 and outputs the first half data to the header determination circuit 223, the header deletion circuit 224, and the data output circuit 227. In this case, since the read data is not the cancellation-of-significant digits data, the command conversion circuit 222 does not receive the second half read instruction and does not read the second half data.

The header determination circuit 223 receives the first half data from the command conversion circuit 222. Then, the header determination circuit 223 reads data of two memory entries from the head of the first half data and acquires a data header. Then, the header determination circuit 223 determines whether or not data of a single memory entry from the head of the data header matches a fixed pattern. When the data of the single memory entry matches the fixed pattern, the header determination circuit 223 outputs a format conversion instruction signal to the header deletion circuit 224, the precision restoration processing circuit 225, the data buffer 226, and the data output circuit 227. Thereafter, when the reading of the data of the cancellation-of-significant digits data length is completed, the header determination circuit 223 stops outputting the format conversion instruction signal.

Meanwhile, when the data of a single memory entry does not match the fixed pattern, the header determination circuit 223 outputs a second half output instruction to the instruction division circuit 221.

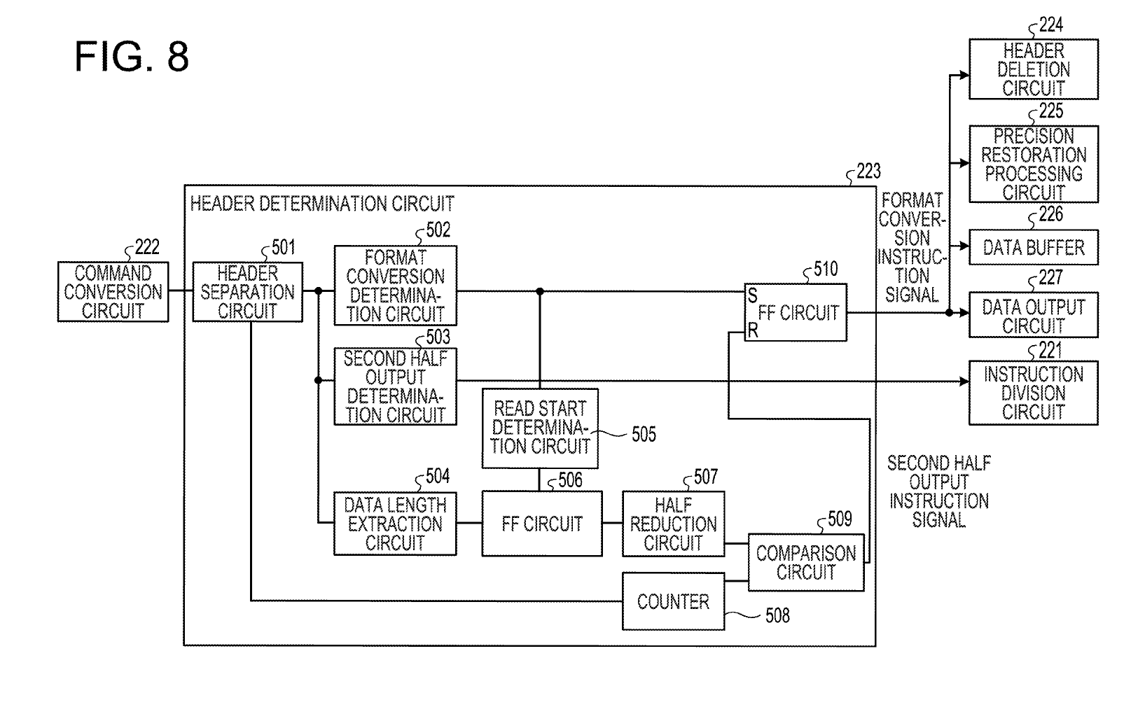

Here, a specific example of the configuration of the header determination circuit 223 will be described with reference to FIG. 8. FIG. 8 is a view illustrating an example of the configuration of the header determination circuit.

The header determination circuit 223 includes a header separation circuit 501, a format conversion determination circuit 502, a second half output determination circuit 503, a data length extraction circuit 504, a read start determination circuit 505, an FF circuit 506, a half reduction circuit 507, a counter 508, a comparison circuit 509, and an FF circuit 510.

The header separation circuit 501 receives the first half data from the command conversion circuit 222. Then, the header separation circuit 501 acquires data of two memory entries from the head of the received first half data. Then, the header separation circuit 501 outputs the acquired data of two memory entries to the format conversion determination circuit 502 and the second half output determination circuit 503. Further, the header separation circuit 501 outputs the first half data to the counter 508.

The format conversion determination circuit 502 receives from the header separation circuit 501 the data input for two memory entries from the head of the first half data. Then, the format conversion determination circuit 502 determines whether or not a data pattern of a single memory entry from the head of the received data matches a fixed pattern. When the data pattern of a single memory entry matches the fixed pattern, the format conversion determination circuit 502 outputs a format conversion instruction signal to the read start determination circuit 505 and the FF circuit 510.

The second half output determination circuit 503 receives from the header separation circuit 501 the data input for two memory entries from the head of the first half data. Then, the second half output determination circuit 503 determines whether or not a data pattern for the single memory entry from the head of the received data matches a fixed pattern. When the data pattern of a single memory entry does not match the fixed pattern, the second half output determination circuit 503 outputs a second half output instruction signal to the instruction division circuit 221.

The data length extraction circuit 504 receives from the header separation circuit 501 the data input for two memory entries from the head of the first half data. Then, the data length extraction circuit 504 acquires the data length stored in an area corresponding to the second memory entry from the head of the received data. Then, the data length extraction circuit 504 outputs the acquired data length to the FF circuit 506.

Upon receiving the second half output instruction signal from the format conversion determination circuit 502, the read start determination circuit 505 issues an output instruction to the FF circuit 506. For example, descriptions will be given to a case where, when the value of a signal input from the format conversion determination circuit 502 is Low, it indicates that the second half output instruction signal is not input, and, when the value is High, it indicates that the second half output instruction signal is input. In this case, the read start determination circuit 505 detects the rising edge of the signal input from the format conversion determination circuit 502. Upon detecting the rising edge of the signal input from the format conversion determination circuit 502, the read start determination circuit 505 issues an output instruction to the FF circuit 506.

The FF circuit 506 receives the data length from the data length extraction circuit 504. Then, the FF circuit 506 holds the received data length. Thereafter, the FF circuit 506 receives the output instruction from the read start determination circuit 505 and outputs the held data length to the half reduction circuit 507.

The half reduction circuit 507 receives the data length from the FF circuit 506. Then, the half reduction circuit 507 calculates half of the data length to acquire the cancellation-of-significant digits data length. Then, the half reduction circuit 507 outputs the cancellation-of-significant digits data length to the comparison circuit 509.

The counter 508 receives the first half data from the header separation circuit 501. Then, the counter 508 starts counting the length of the received data of the first half data. Then, the counter 508 outputs a count value to the comparison circuit 509.

The comparison circuit 509 receives the cancellation-of-significant digits data length from the half reduction circuit 507. In addition, the comparison circuit 509 receives the count value indicating the length of the received data from the counter 508. The comparison circuit 509 compares the cancellation-of-significant digits data length with the count value. When the count value reaches the cancellation-of-significant digits data length, the comparison circuit 509 outputs a read end signal to the FF circuit 510.

The FF circuit 510 is a set/reset type flip-flop. Upon receiving a read start signal output from the format conversion determination circuit 502 at a set terminal, the FF circuit 510 outputs a format conversion instruction signal to the header deletion circuit 224, the precision restoration processing circuit 225, the data buffer 226, and the data output circuit 227. Thereafter, upon receiving a read end signal output from the comparison circuit 509 at a reset terminal, the FF circuit 510 stops outputting the format conversion instruction signal.

Referring back to FIG. 6, the header deletion circuit 224 receives the first half data from the command conversion circuit 222. Then, when the format conversion instruction signal is received from the header determination circuit 223, the header deletion circuit 224 deletes the data header by deleting the data of two memory entries from the head of the first half data. Thereafter, the header deletion circuit 224 outputs to the precision restoration processing circuit 225 the first half data from which the data header has been deleted.

Meanwhile, when the format conversion instruction signal is not received from the header determination circuit 223, the header deletion circuit 224 outputs the first half data to the precision restoration processing circuit 225 without deleting the data header. Thereafter, the header deletion circuit 224 receives the second half data from the command conversion circuit 222. Then, the header deletion circuit 224 outputs the second half data to the precision restoration processing circuit 225 without deleting the data header.

The precision restoration processing circuit 225 receives from the header deletion circuit 224 the first half data from which the data header has been deleted. Hereinafter, the first half data from which the data header has been deleted is simply referred to as first half data. Then, upon receiving the format conversion instruction signal from the header determination circuit 223, the precision restoration processing circuit 225 performs restoration-of-significant digits processing to convert the first half data to data having digits before executing the cancellation-of-significant digits processing. For example, when the cancellation-of-significant digits data as the first half data is data of five digits, the precision restoration processing circuit 225 adds 0 of five digits later to restore the first half data to data of ten digits. Thereafter, the precision restoration processing circuit 225 outputs the first half data subjected to the restoration-of-significant digits processing to the data buffer 226.

In addition, when the first half data is the cancellation-of-significant digits data, the second half data is not read. Therefore, since the precision restoration processing circuit 225 does not receive the second half data and also does not receive the format conversion instruction signal after the processing of the first half data, the processing for the second half data is not performed.

The data buffer 226 receives from the precision restoration processing circuit 225 the first half data subjected to the restoration-of-significant digits processing. The data buffer 226 holds the received first half data. Upon receiving the format conversion instruction signal from the header determination circuit 223, the data buffer 226 outputs the held first half data to the data output circuit 227. Similarly to the precision restoration processing circuit 225, the data buffer 226 also does not perform the processing for the second half data.

The data output circuit 227 receives from the data buffer 226 the first half data subjected to the restoration-of-significant digits processing. Further, the data output circuit 227 receives from the command conversion circuit 222 the first half data before being subjected to the restoration-of-significant digits processing.

When the format conversion instruction signal is being received from the header determination circuit 223, the data output circuit 227 selects the first half data subjected to the restoration-of-significant digits processing and outputs the same to the core 101. When the format conversion instruction signal is not being received from the header determination circuit 223, the data output circuit 227 selects the first half data before being subjected to the restoration-of-significant digits processing and outputs the same to the core 101.

Thereafter, when the format conversion instruction signal is being received from the header determination circuit 223, the data output circuit 227 ends the output of data. Meanwhile, when the format conversion instruction signal is not being received from the header determination circuit 223, the data output circuit 227 outputs to the core 101 the second half data input from the command conversion circuit 222.

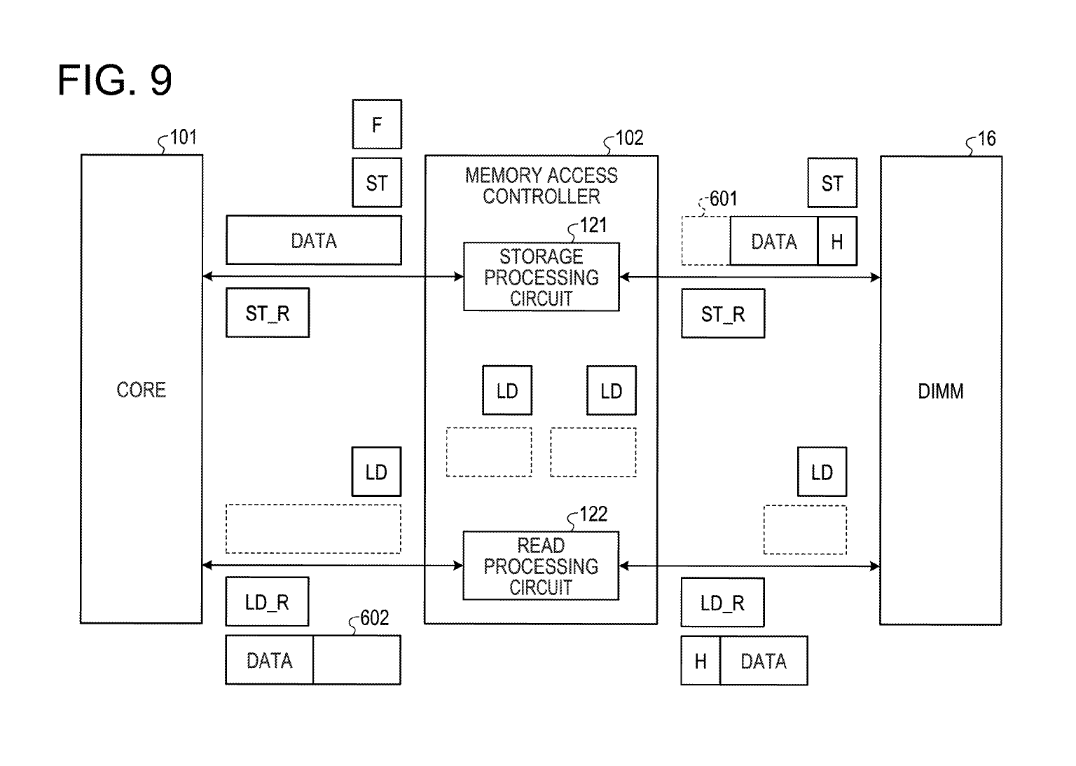

Next, signals to be transmitted and received in storage of data subjected to the cancellation-of-significant digits processing and read of data subjected to the restoration-of-significant digits processing will be described with reference to FIG. 9. FIG. 9 is a view illustrating the state of signals in the cancellation-of-significant digits processing and the restoration-of-significant digits processing.

FIG. 9 illustrates signals to be exchanged between the core 101, the memory controller 102, and the DIMM 16. A signal F represents a cancellation-of-significant digits flag signal. A signal ST represents a storage instruction. Data represents data instructed to be stored by the storage instruction or data read by a read instruction. A region H represents a data header. A signal ST_R represents a storage response. LD represents a read instruction. A frame surrounded by a broken line represents data designated by the read instruction.

When performing the cancellation-of-significant digits processing to store data, the core 101 outputs to the storage processing circuit 121 the cancellation-of-significant digits flag signal, the storage instruction, and the data to be stored. In this state, the data has the data length before the cancellation-of-significant digits processing. Then, upon receiving the cancellation-of-significant digits flag signal, the storage processing circuit 121 determines execution of the cancellation-of-significant digits flag signal processing. Next, the storage processing circuit 121 performs the cancellation-of-significant digits processing for the data, adds the generated data header to the data, and outputs the data added with the generated data header to the DIMM 16, together with the storage instruction converted for the DIMM 16, to store the data header and the data in the DIMM 16. In this case, an area 601, which corresponds to a difference between the data length designated by the core 101 and a length obtained by adding the data subjected to the cancellation-of-significant digits flag signal processing and the data header, is an unused area in the DIMM 16. Then, since the storage processing circuit 121 does not transfer data corresponding to the area 601, the bus utilization rate can be reduced as much.

In addition, when reading the cancellation-of-significant digits data stored in the DIMM 16, the core 101 outputs to the read processing circuit 122 a read instruction for data not subjected to the cancellation-of-significant digits processing. That is, the core 101 instructs reading of data having a data length by a read instruction in a state in which no cancellation-of-significant digits processing has been performed.

The read processing circuit 122 divides the received read instruction into a first half read instruction and a second half read instruction. In FIG. 9, the read instructions illustrated above the read processing circuit 122 correspond to the first half read instruction and the second half read instruction. Thereafter, the read processing circuit 122 outputs the first half read instruction to the DIMM 16. In this case, the data length designating the reading is the cancellation-of-significant digits data length.

Thereafter, the read processing circuit 122 receives the first half read instruction and acquires from the DIMM 16 the first half data including the data header, together with a read response. In this case, the read processing circuit 122 checks that the data header includes header information having a fixed pattern, and discards the second half read instruction. Next, the read processing circuit 122 deletes the data header from the first half data and performs the restoration-of-significant digits processing on the cancellation-of-significant digits data to converts the first half data to data having the data length designated by the read instruction by the core 101. For example, the read processing circuit 122 adds data 602 for returning to the digits before the cancellation-of-significant digits processing to data obtained by deleting the data header from the first half data. Then, the read processing circuit 122 outputs to the core 101 the data to which the data 602 is added, together with the read response.

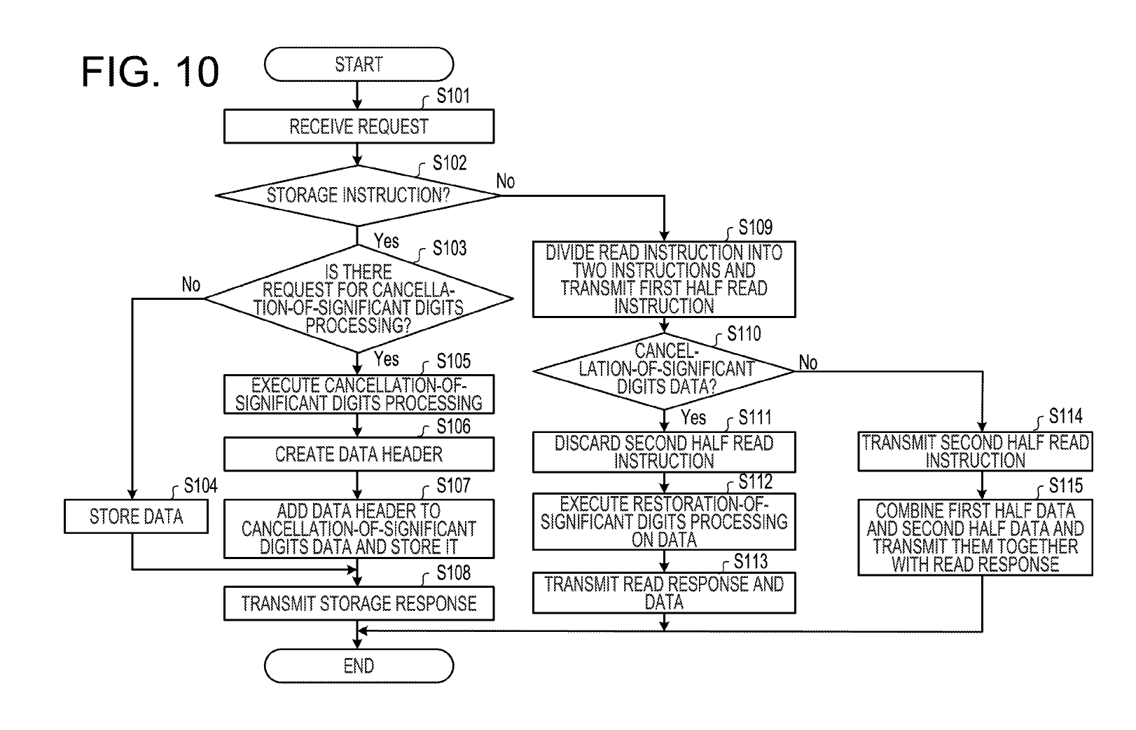

Next, the overall flow of data storage processing and read processing by memory controller 102 according to this embodiment will be described with reference to FIG. 10. FIG. 10 is a flowchart of data storage processing and read processing by the memory controller according to the first embodiment.

The memory controller 102 receives a request from the core 101 (step S101).

Next, the memory controller 102 determines whether or not the request is a storage instruction (step S102).

When it is determined that the request is a storage instruction (“Yes” in step S102), the storage processing circuit 121 of the memory controller 102 determines whether or not there is a request for cancellation-of-significant digits processing, depending on whether or not a cancellation-of-significant digits flag signal is input (step S103).

When it is determined that there is no request for cancellation-of-significant digits processing (“No” in step S103), the storage processing circuit 121 stores data in the DIMM 16 according to the storage instruction (step S104). Thereafter, the storage processing circuit 121 proceeds to step S108.

Meanwhile, when it is determined that there is a request for cancellation-of-significant digits processing (“Yes” in step S103), the storage processing circuit 121 performs the cancellation-of-significant digits processing on the data designated by the storage instruction (step S105).

Next, the storage processing circuit 121 creates a data header including the header information having a unique pattern and the data length (step S106).

Next, the storage processing circuit 121 adds the data header to the cancellation-of-significant digits data and stores it in the DIMM 16 (step S107). At this time, data of a size obtained by excluding the data length of the data header and the cancellation-of-significant digits data length from the data length designated by the storage instruction is not transmitted to the DIMM 16 which then keeps the area of the data unused.

Thereafter, the storage processing circuit 121 transmits the storage response to the core 101 (step S108).

Meanwhile, when it is determined that the request is a read instruction rather than the storage instruction (“No” in step S102), the read processing circuit 122 of the memory controller 102 divides the read instruction into two instruction, that is, the first half read instruction and the second half read instruction, and transmits the first half read instruction to the DIMM 16 (step S109).

The read processing circuit 122 acquires the first half data from the DIMM 16. Then, the read processing circuit 122 determines from the data header included in the first half data whether or not the data included in the first half data is the cancellation-of-significant digits data (step S110).

When it is determined that the data included in the first half data is the cancellation-of-significant digits data (“Yes” in Step S110), the read processing circuit 122 discards the second half read instruction (Step S111).

Next, the read processing circuit 122 performs the restoration-of-significant digits processing on the data acquired by excluding the data header from the first half data (step S112).

Thereafter, the read processing circuit 122 transmits to the core 101 the read response and the data subjected to the restoration-of-significant digits processing (step S113).

Meanwhile, when it is determined that the data included in the first half data is not the cancellation-of-significant digits data (“No” in step S110), the read processing circuit 112 transmits the second half read instruction to the DIMM 16 (step S114).

Thereafter, the read processing circuit 122 acquires the second half data from the DIMM 16. Then, the read processing circuit 122 combines the first half data and the second half data and transmits them to the core 101, together with the read response (step S115).

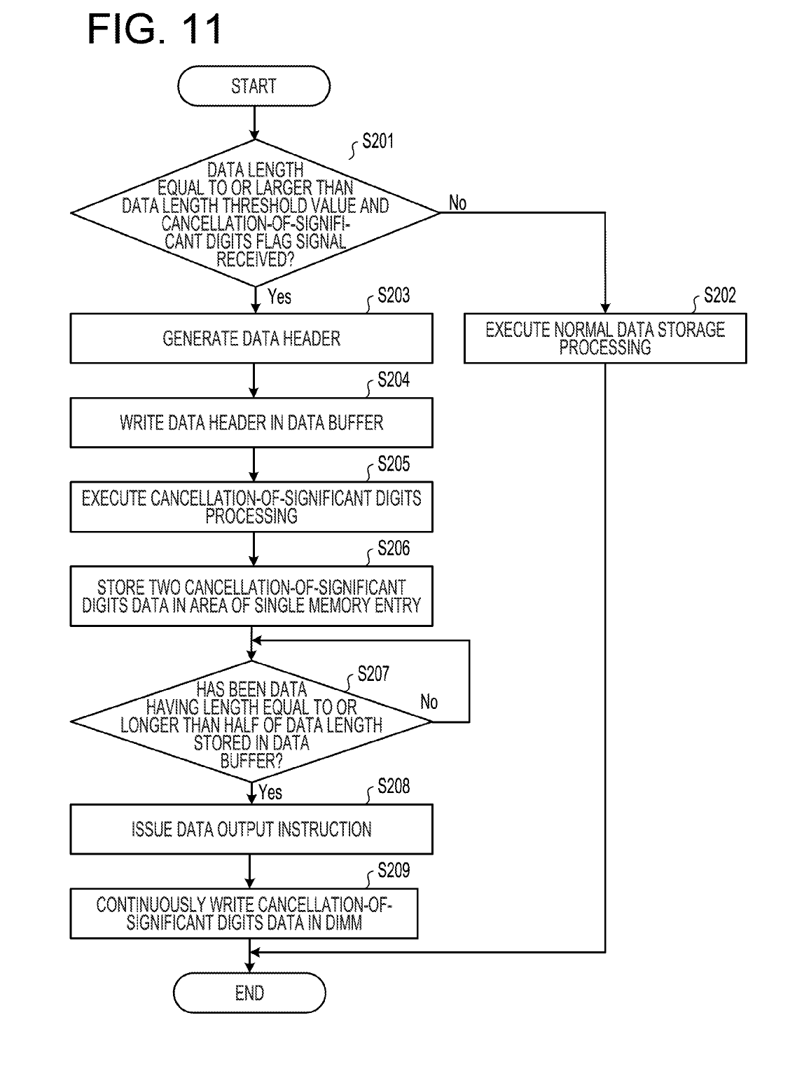

Next, a flow of data storage processing by the storage processing circuit 121 according to this embodiment will be described with reference to FIG. 11. FIG. 11 is a flowchart of data storage processing by the storage processing circuit according to the first embodiment.

The data header generation circuit 211 determines whether or not the data length is equal to or larger than the data length threshold value and whether or not a cancellation-of-significant digits flag signal has been received (step S201). This step is performed by, for example, the comparison circuit 302 and the determination circuit 301 illustrated in FIG. 4.

When it is determined that the data length is equal to or smaller than the data length threshold value or when a cancellation-of-significant digits flag signal has not been received (“No” in step S201), the data header generation circuit 211 executes normal data storage processing (step S202). This step is implemented, for example, when the data length selection circuit 308 of FIG. 4 outputs to the command conversion circuit 215 the data length designated by the storage instruction.

Meanwhile, when it is determined that the data length is equal to or larger than the data length threshold value and a cancellation-of-significant digits flag signal has been received (“Yes” in step S201), the data header generation circuit 211 generates a data header (step S203). This step is performed, for example, by the header output circuit 310 illustrated in FIG. 4.

Then, the data header generation circuit 211 writes the generated data header in the data buffer 213 (step S204). This step is performed, for example, by the header output circuit 310 illustrated in FIG. 4.

Next, the data header generation circuit 211 executes the cancellation-of-significant digits processing on the data designated by the storage instruction to generate the cancellation-of-significant digits data (step S205). This step is performed, for example, by the half reduction circuit 303 illustrated in FIG. 4. Then, the storage processing circuit 121 writes the cancellation-of-significant digits data to the data buffer 213.

The data buffer 213 receives the cancellation-of-significant digits data from the storage processing circuit 121 and stores two cancellation-of-significant digits data in an area of a single memory entry (step S206).

The data header generation circuit 211 determines whether or not data having a length equal to or longer than half of the data length has been stored in the data buffer 213 (step S207). When it is determined that storage of data having a length equal to or longer than half of the data length has not been completed (“No” in step S207), the data header generation circuit 211 waits until data having a length equal to or longer than half of the data length is stored in the data buffer 213 (step S207).

Meanwhile, when it is determined that data having a length equal to or longer than half of the data length has been stored in the data buffer 213 (“Yes” in step S207), the data header generation circuit 211 issues a data output instruction to the data buffer 213 and the data output circuit 214 (step S208). This step is performed, for example, by the counter 305 and the comparison circuit 307 illustrated in FIG. 4.

The data buffer 213 outputs the cancellation-of-significant digits data to the data output circuit 214. The data output circuit 214 selects the cancellation-of-significant digits data input from the data buffer 213 and outputs the same to the command conversion circuit 215. The command conversion circuit 215 generates a storage instruction for the DIMM 16 of the cancellation-of-significant digits data input from the data output circuit 214 and outputs the same to the DIMM 16, thereby continuously writing the cancellation-of-significant digits data in the DIMM 16 (step S209).

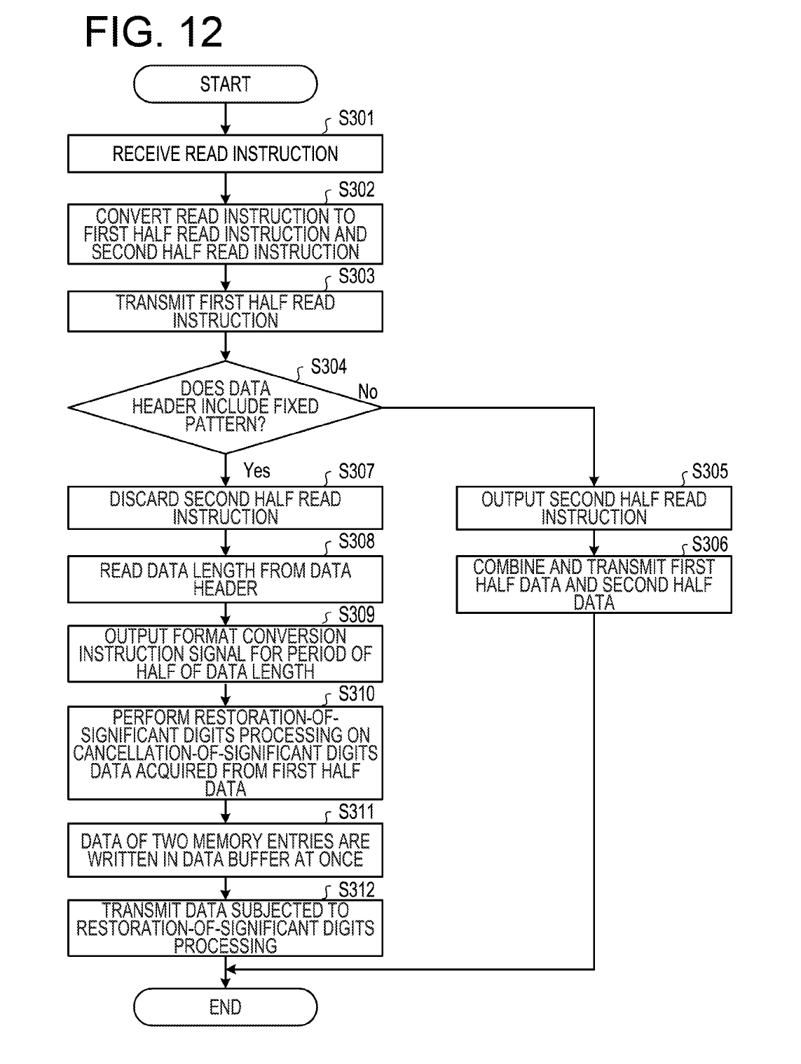

Next, a flow of data read processing by the read processing circuit 122 according to this embodiment will be described with reference to FIG. 12. FIG. 12 is a flowchart of data read processing by the read processing circuit according to the first embodiment.

The instruction division circuit 221 receives a read instruction from the core 101 (step S301).

Next, the instruction division circuit 221 converts the received read instruction to the first half read instruction and the second half read instruction (step S302).

Next, the instruction division circuit 221 transmits the first half read instruction to the DIMM 16 via the command conversion circuit 222 (step S303). Thereafter, the header determination circuit 223 acquires the first half data from the DIMM 16 via the command conversion circuit 222.

Next, the header determination circuit 223 acquires a data header from the first half data. Then, the header determination circuit 223 determines whether or not the data header includes a fixed pattern (step S304).

When it is determined that the data header does not include a fixed pattern (“No” in step S304), the header determination circuit 223 outputs the second half output instruction signal to the instruction division circuit 221. This step is performed, for example, by the second half output determination circuit 503 in FIG. 8. Upon receiving the second half output instruction signal, the instruction division circuit 221 outputs the second half read instruction to the DIMM 16 via the command conversion circuit 222 (step S305).

The data output circuit 227 receives the first half data and the second half data from the command conversion circuit 222. Then, the data output circuit 227 combines the first half data and the second half data and transmits them to the core 101 (step S306).

Meanwhile, when it is determined that the data header includes a fixed pattern (“Yes” in step S304), the instruction division circuit 221 discards the second half read instruction (step S307).

In addition, the header determination circuit 223 reads the data length from the data header (step S308). This step is performed, for example, by the data length extraction circuit 504 illustrated in FIG. 8.

Next, the header determination circuit 223 outputs the format conversion instruction signal to the header deletion circuit 224, the precision restoration processing circuit 225, the data buffer 226 and the data output circuit 227 for a period of half of the data length (step S309). This step is performed, for example, by the format conversion determination circuit 502, the comparison circuit 509 and the FF circuit 510 illustrated in FIG. 8.

The header deletion circuit 224 receives the first half data from the command converting circuit 222. Then, the header deletion circuit 224 deletes the data header from the first half data to acquire the cancellation-of-significant digits data. Then, the header deletion circuit 224 outputs the cancellation-of-significant digits data to the precision restoration processing circuit 225.

The precision restoration processing circuit 225 receives the cancellation-of-significant digits data from the header deletion circuit 224. Then, the precision restoration processing circuit 225 performs the restoration-of-significant digits processing on the cancellation-of-significant digits data acquired from the first half data (step S310). Thereafter, the precision restoration processing circuit 225 transmits the data subjected to the restoration-of-significant digits processing to the data buffer 226.

The data for two memory entries are written in the data buffer 226 at once (step S311). Thereafter, the data buffer 226 outputs the data subjected to the restoration-of-significant digits processing to the data output circuit 227.

The data output circuit 227 sequentially outputs the data subjected to the restoration-of-significant digits processing to the core 101 (step S312).

As described above, the memory controller according to the present embodiment lowers the precision of data and stores the data lowered in the precision in a memory, recovers the precision of data to a format of precision designated by a read request at the time of reading, and outputs the data with recovered precision to the core. Thus, it is possible to reduce the amount of data to be exchanged with the memory. Therefore, the bus utilization rate may be suppressed and the throughput of data exchange with the memory may be increased, thereby increasing the computational efficiency of the information processing apparatus.

In particular, the error data and weight difference data calculated in the deep learning are data that are not required for explicit values and computation in the deep learning is computation that is not required for explicit solutions. Therefore, in the deep learning, the data subjected to processing for lowering the precision, such as the cancellation-of-significant digits processing used in the present embodiment, may be used for computation, so that the server according to the present embodiment may improve the computational efficiency while maintaining required computational performance.

### Second Embodiment

Next, a second embodiment will be described. A server according to this embodiment has the same configuration as the server illustrated in FIG. 1 and a GPU according to this embodiment may be illustrated by the block diagram of FIG. 2. In this embodiment, the timing at which the core 101 instructs the memory controller 102 to execute the cancellation-of-significant digits processing will be described. Here, a case where the server 1 executes the deep learning will be described.

As for the timing at which the memory controller 102 performs the cancellation-of-significant digits processing, an initial stage of learning in the deep learning may be considered. That is, the server 1 may first learn roughly and then learn using high precision data at a stage where the learning has progressed, to complete the deep learning. Therefore, in order to implement the deep learning, the core 101 outputs a cancellation-of-significant digits flag signal to the memory controller 102 instructing to execute the cancellation-of-significant digits processing at the timing described below.

At the start of the deep learning, the core 101 outputs the cancellation-of-significant digits flag signal to the memory controller 102 instructing to execute the cancellation-of-significant digits processing.

Thereafter, the core 101 counts the iteration of execution of the learning and outputs a cancellation-of-significant digits flag signal to the memory controller 102 for stopping the cancellation-of-significant digits processing when the learning iteration exceeds a predetermined number of times. For example, the core 101 may control the execution of the cancellation-of-significant digits processing by setting a value of the cancellation-of-significant digits flag signal to High when instructing the execution of the cancellation-of-significant digits processing, and by setting the value of the cancellation-of-significant digits flag signal to Low when instructing the non-execution of the cancellation-of-significant digits processing.

In addition, the core 101 obtains the quality of estimation by using a LOSS function, which is a function expressing poor quality estimated each time learning is completed once. Then, when the estimated quality is equal to or lower than a predetermined quality reference value, the core 101 outputs to the memory controller 102 the cancellation-of-significant digits flag signal for stopping the cancellation-of-significant digits processing.

Here, the timings at which the cancellation-of-significant digits flag signals for stopping the above-mentioned two cancellation-of-significant digits processings are output may be used in combination or alone.

Further, when the timings are timings at which computation not requiring high precision is performed, the memory controller 102 may execute the cancellation-of-significant digits processing at a timing other than these timings. For example, the core 101 stores in advance a specific layer for executing the cancellation-of-significant digits processing out of plural layers on which learning in the deep learning is performed in advance. For the specific layer, for example, a convolution layer or the like can be designated. Then, the core 101 outputs the cancellation-of-significant digits flag signal to the memory controller 102 instructing to execute the cancellation-of-significant digits processing at the timing of start of learning in the specific layer. Thereafter, the core 101 outputs the cancellation-of-significant digits flag signal to the memory controller 102 for stopping the cancellation-of-significant digits processing at the timing of end of learning in the specific layer.

As described above, the core according to the present embodiment causes the memory controller 102 to execute the cancellation-of-significant digits processing at the timing at which the computation that does not require high precision is performed. Thus, the server according to the present embodiment can efficiently perform deep learning with high precision.

### Third Embodiment

Next, a third embodiment will be described. The server according to this embodiment has the same configuration as illustrated in FIG. 1 and a GPU is illustrated by the block diagram of FIG. 2. In this embodiment, the core 101 uses the cancellation-of-significant digits processing to evaluate the quality of a learning sample or a deep learning network. Here, a case where the server 1 executes deep learning will be described.

In the previous stage of learning, the core 101 outputs a cancellation-of-significant digits flag signal instructing to execute the cancellation-of-significant digits processing and performs low precision learning in a short time. Then, the core 101 determines whether or not the result of learning by the low precision learning is equal to or greater than a predetermined learning result. For example, the core 101 determines whether or not the precision of image recognition by the low precision learning has reached a predetermined precision.

When it is determined that the result of learning by the low precision learning is equal to or greater than the predetermined learning result, the core 101 outputs the cancellation-of-significant digits flag signal to the memory controller 102 for stopping the cancellation-of-significant digits processing. Then, the core 101 executes the deep learning by high precision learning.

Meanwhile, when it is determined that the learning result by the low precision learning is less than the predetermined learning result, the core 101 changes the learning sample or the deep learning network. The core 101 changes the deep learning network, for example, by changing parameters. Thereafter, the core 101 outputs the cancellation-of-significant digits flag signal instructing to execute the cancellation-of-significant digits processing and performs the low precision learning in a short time. The core 101 iterates the change of the learning sample or the deep learning network until the learning result by the low precision learning becomes equal to or greater than the predetermined learning result. Then, when the learning result by the low precision learning becomes equal to or greater than the predetermined learning result, the core 101 outputs the cancellation-of-significant digits flag signal to the memory controller 102 for stopping the cancellation-of-significant digits processing. Thereafter, the core 101 executes the deep learning by high precision learning.

As described above, the core according to the present embodiment learns with low precision at the previous stage of the learning, requests an appropriate setting of the learning sample or the deep learning network, and then uses the requested setting to execute the deep learning by high precision learning. Thus, the server according to the present embodiment can efficiently perform the deep learning with high precision.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing apparatus comprising:
an arithmetic processing circuit configured to execute arithmetic processing;
a memory configured to store data;
a storage processing circuit coupled to the arithmetic processing circuit and the memory, configured to generate low precision data having a shorter data length than first data designated to be stored by a storage instruction received from the arithmetic processing circuit, and store the generated low precision data in the memory; and
a read processing circuit coupled to the arithmetic processing circuit and the memory, configured to read from the memory the low precision data corresponding to second data designated to be read by a read instruction received from the arithmetic processing circuit, return the read low precision data to a format of the data length of the second data, and output the low precision data returned to the format to the arithmetic processing circuit.

2. The information processing apparatus according to claim 1, wherein the storage processing circuit stores the first data in the memory when the data length of the first data is less than a predetermined length, and stores the low precision data in the memory when the data length of the first data is equal to or more than the predetermined length.

3. The information processing apparatus according to claim 1, wherein the storage processing circuit executes cancellation-of-significant digits data by executing cancellation-of-significant digits processing to make the precision of the first data shorter than the data length of the first data, stores the cancellation-of-significant digits data generated in some of storage areas of the first data in the memory designated by the storage instruction, and set the remaining areas as unused areas, and
the read processing circuit divides the read instruction into a first read instruction for reading data from the some areas and a second read instruction for reading data from the unused areas, and discards the second read instruction when the read data read based on the first read instruction is the cancellation-of-significant digits data.

4. The information processing apparatus according to claim 3, wherein the storage processing circuit adds identification information indicating that the data is the cancellation-of-significant digits data, and stores the cancellation-of-significant digits data in the memory, and
the read processing circuit determines whether or not the read data read based on the first read instruction is the cancellation-of-significant digits data, based on the identification information.

5. A memory controller comprising:
a storage processing circuit coupled to an arithmetic processing circuit and a memory, configured to generate low precision data having a shorter data length than first data designated to be stored by a storage instruction received from the arithmetic processing circuit, and store the generated low precision data in the memory; and
a read processing circuit coupled to the arithmetic processing circuit and the memory, configured to read from the memory the low precision data corresponding to second data designated to be read by a read instruction received from the arithmetic processing circuit, return the read low precision data to a format of the data length of the second data, and output the low precision data returned to the format to the arithmetic processing circuit.

6. The memory controller according to claim 5, wherein the storage processing circuit stores the first data in the memory when the data length of the first data is less than a predetermined length, and stores the low precision data in the memory when the data length of the first data is equal to or more than the predetermined length.

7. The memory controller according to claim 5, wherein the storage processing circuit executes cancellation-of-significant digits data by executing cancellation-of-significant digits processing to make the precision of the first data shorter than the data length of the first data, stores the cancellation-of-significant digits data generated in some of storage areas of the first data in the memory designated by the storage instruction, and set the remaining areas as unused areas, and
the read processing circuit divides the read instruction into a first read instruction for reading data from the some areas and a second read instruction for reading data from the unused areas, and discards the second read instruction when the read data read based on the first read instruction is the cancellation-of-significant digits data.

8. The memory controller according to claim 5, wherein the storage processing circuit adds identification information indicating that the data is the cancellation-of-significant digits data, and stores the cancellation-of-significant digits data in the memory, and
the read processing circuit determines whether or not the read data read based on the first read instruction is the cancellation-of-significant digits data, based on the identification information.

9. A control method for an information processing apparatus including an arithmetic processing circuit that executes arithmetic processing, a memory that stores data, a storage processing circuit that couples to the arithmetic processing circuit and the memory, and a read processing circuit that couples to the arithmetic processing circuit and the memory, the method comprising:
generating, by the storage processing circuit, low precision data having a shorter data length than first data designated to be stored by a storage instruction received from the arithmetic processing circuit, and storing the generated low precision data in the memory; and
reading, by the read processing circuit, from the memory the low precision data corresponding to second data designated to be read by a read instruction received from the arithmetic processing circuit, returning the read low precision data to a format of the data length of the second data, and outputting the low precision data returned to the format to the arithmetic processing circuit.
